(19) United States
(12) Patent Application Publication
(10) Pub. No.: US 2007/0039870 A1
(43) Pub. Date: Feb. 22, 2007

(54) Cartridge filter

(75) Inventor: Thomas J. Scanlan, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/206,413

(22) Filed: Aug. 18, 2005

(51) Int. Cl. B01D 35/28

(52) U.S. Cl. 210/445; 210/455; 210/450

(57) ABSTRACT

There is provided a liquid filter comprising a filter vessel having a removable cover, a fluid inlet, an engagement lip for a filter and a fluid outlet, an open top, fluid impermeable sidewalls, and a fluid outlet at a bottom of the insert. Into the filter vessel is inserted a water impermeable insert having an insert lip engageable in a sealing relationship with the filter vessel engagement lip. A single cartridge filter is inserted within the cartridge filter insert having a generally solid top surface, a bottom fluid outlet sealingly engageable with the insert outlet and a filter material. The cartridge filter top surface forms a weir for diverting fluid to be filtered toward an annular opening created between the filter cartridge and the insert, the annular opening having a cross sectional area, which generally is from 25 to 100% of the cross sectional area of the filter cartridge outlet opening.

### BACKGROUND OF THE INVENTION

This invention relates to a liquid filter and insert to convert a bag type filter vessel to a cartridge type filter vessel.

In the liquid filtration art there are used canister type filters vessels, which use either cartridge filters or bag filters. Bag type filters are illustrated for example in U.S. Pat. Nos. 4,259,188; 3,814,261; and 3,640,392 with bag type filters the fluid to be filtered flows from a central inlet into the filter bag and out of the bag to an exit. A alternative type liquid filter vessel used in the art are cartridge type filters such as described in U.S. Pat. Nos. 3,319,793; 3,050,193; 5,770,066 and 5,527,463. Cartridge type filters are generally used in vessels where liquid flows into the vessel from a side wall and from the side wall in through the side walls of the cartridge filters and exits through a central tube in the cartridge filter to an axially positioned exit. As such the fluid in cartridge filter vessels is flowing in the opposite direction as filter vessels fitted with bag type filters.

U.S. Pat. No. 4,610,787 proposes adapting bag type filter vessels to be used with cartridge type filters by providing a cartridge carrying insert, which is adapted to be fitted into the housing of a filter bag vessel where a bag would normally be placed. The insert is placed in compressive contact with the filter vessel cover. The vessel cover holds the insert in place simultaneously with holding a multitude of cartridges in place by use of helical springs placed on the cartridge ends. The spring fitted cartridges are also in compression contact with the filter vessel cover. This arrangement requires a compressive cover and flange, which often is not present in bag type filters, which sometimes have an open head space area over the bags. It also requires fitting conventional cartridge filters with springs. As such, this system is unusable in certain bag filter vessels and is complicated in requiring compressive engagement between multiple elements simultaneously when the filter vessel cover is closed.

It is an object of the present invention to provide a novel insert and filter cartridge arrangement to convert a bag type filter into a cartridge type without the necessity of a compressive seal against the cartridge filters placed in the insert. Further objects of the invention will become apparent upon reading the description of the invention, which are not limited by such objects.

### SUMMARY OF THE INVENTION

The invention is described as a liquid filter comprising a filter vessel having a removable cover, a fluid inlet, an engagement lip for a filter and a fluid outlet, an open top, fluid impermeable sidewalls, and a fluid outlet at a bottom of the insert. Into the filter vessel is inserted a water impermeable insert having an insert lip engageable in a sealing relationship with the filter vessel engagement lip. A single cartridge filter is inserted within the cartridge filter insert having a generally solid top surface, a bottom fluid outlet sealingly engageable with the insert outlet and a filter material. The cartridge filter top surface forms a weir for diverting fluid to be filtered toward an annular opening created between the filter cartridge and the insert, the annular opening having a cross sectional area, which generally is from 25 to 100% of the cross sectional area of the filter cartridge outlet opening.

### BRIEF DESCRIPTION OF THE DRAWINGS

FIG. 1 is a longitudinal cross-sectional view of a conventional bag filter vessel.

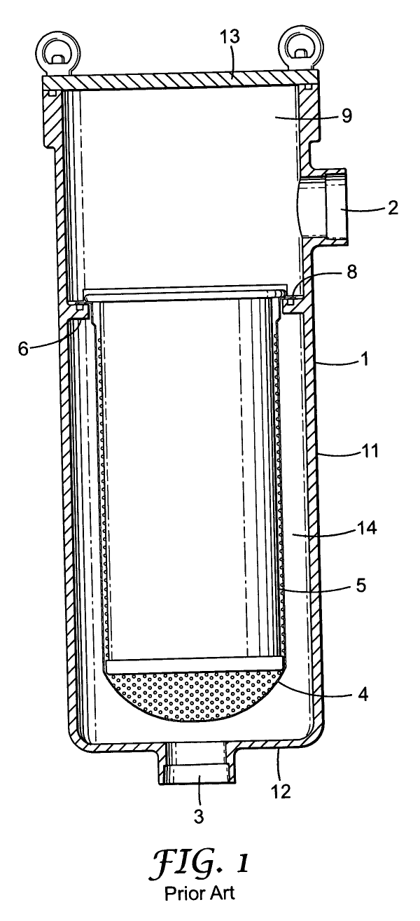

FIG. 2 is a longitudinal cross-sectional view of the invention filter cartridge insert and filter cartridge in a single bag filter vessel.

FIG. 3 is a perspective view of a multiple bag filter vessel housing accommodating multiple filter cartridge inserts and filter cartridges of the present invention.

### DESCRIPTION OF THE PREFERRED EMBODIMENTS

A conventional type of the bag filter vessel 1 has sidewalls 11, which is generally formed as a circular shape. The vessel also has a bottom wall 12 and a lip 6 formed on or within the sidewall onto which a conventional bag filter would rest. The bag filter 5 can include a support basket 4 for preventing the bag 5 from rupturing when liquid entering fluid inlet 2 is under pressure, which pressure would force the bag outward. Liquid entering fluid inlet 2 would enter the head room region 9, flow down through the center of the vessel into the filter bag 5 and out through the holes provided in support basket 4. The filtered liquid would then flow into the annular region 14 surrounding the filter bag 5, and out through exit 3. The bag filter could have a rigid bag lip which would rest against the lip 6 provided on the filter vessel 1 or the lip 8 of the support basket 4, which would keep the bag filter in place during operation. The bag filter could be replaced through cover 13. The cover 13 as shown is not compressably engaged with the bag filter rigid bag lip; however could be used in this manner as described in U.S. Pat. No. 4,610,787.

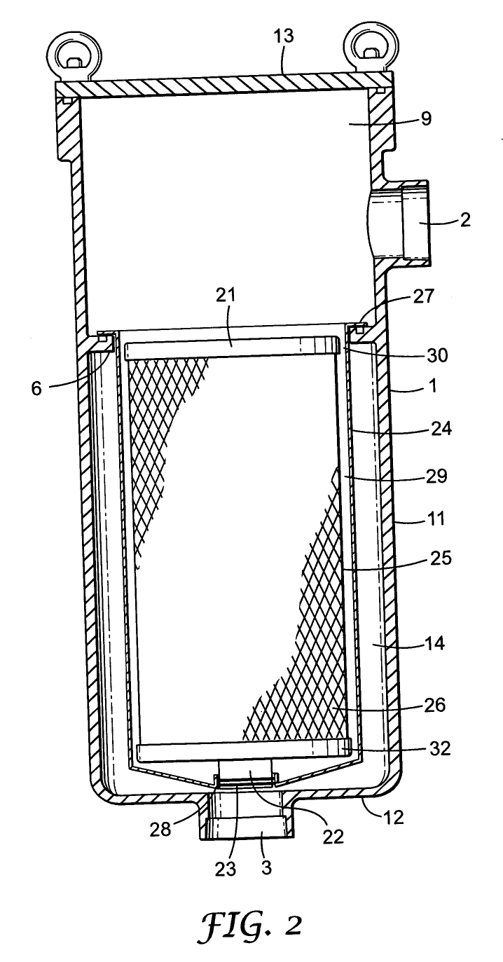

Adaptation of this vessel 1 to be used with a single cartridge type filter 25 is shown in FIG. 2 where the support basket 4 has been replaced with a solid cartridge filter insert 24. The solid cartridge filter insert 24 has a liquid impermeable structure except for a fluid outlet 28 on a bottom wall, into which is inserted a cartridge filter 25 having an outlet opening 22. The outlet opening 22 would generally be provided with O rings 23 to form a seal with the fluid outlet 28. The solid cartridge filter insert 24 has a lip 27 which rests on the lip 6 of the bag filter vessel 1. The single cartridge filter 25 used with the insert has a covering 26, which would generally be formed of a netting or scrim type material to protect the filter medium, the filter material would generally be wrapped around a water permeable central core (not shown), which core terminates in the outlet 22. The cartridge filter 25 has a top 21, which is a solid or generally water impermeable top. The top 21 forms a weir that creates downward pressure in association with the incoming water to be filtered while also diverting the water to an annular opening 30 and then to annular region 29. The annular opening 30 is formed between the cartridge filter top 21 and the solid cartridge filter insert 24, which annular opening 30 allows the entrance of the high pressure fluid to be filtered. Generally the cross-sectional area of this annular opening 30 is within 25 to 100% or 30 to 70% of the cross-sectional area of the outlet 22 or 28. If the annular opening 30 is too large the pressure of the water may force the cartridge filter out of the fluid outlet 28. If the annular opening 30 is too small the water pressure and flow at the filter face may be lowered decreasing particle loading capacity of the cartridge filter. The top 21 generally will have a surface area of about 10 to 100 in² or 20 to 50 in² or 25 to 35 in² and will be 10 to 30 times greater than the annular opening 30 or 15 to 25 times greater.

The cartridge filter top 21 and bottom surface 32 are generally formed from a fluid impermeable rigid material, such as a thermoplastic, with the cartridge filter outlet 22 exiting the bottom surface 32. The outlet 22 is fluid impermeable except for the outlet opening. The outlet 22 can be formed integral with the cartridge filter bottom 32 and/or the fluid permeable central core of the cartridge filter. Suitable cartridge filters are described in U.S. Pat. No. 4,842,739, the substance of which is incorporated by reference in its entirety.

The solid surface of the cartridge filter top 21 with the force of the incoming high pressure filtrate compressively forces the cartridge filter downward keeping the cartridge filter outlet opening 22 pressed into the fluid outlet 28, which also presses the cartridge filter insert against the lip 6 during use. A downward pressure of the liquid with the top acting as a weir serves as an engaging force to keep the cartridge filter and solid filter cartridge insert 24 from floating away from lip 6. The insert lip 27 preferably is provided with a seal or O ring to ensure a proper seal and prevent bypass of any liquid.

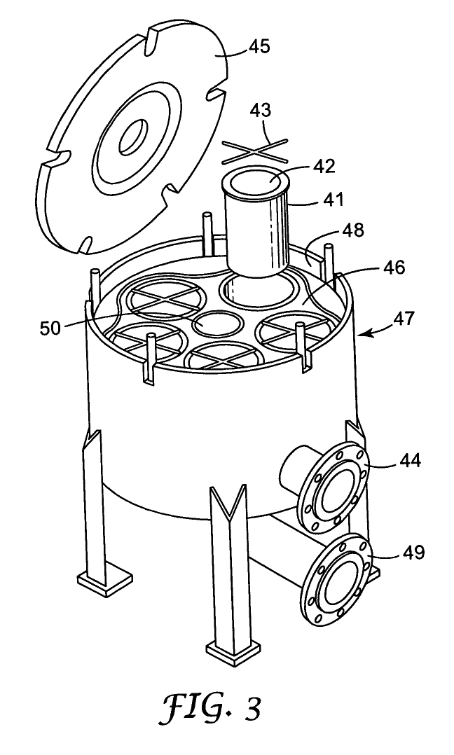

Optionally as shown in FIG. 3 a clip 43 or other restraining element could be used to keep the cartridge filter temporarily in place during the initial start up of the filter vessel. This is shown in multiple filter vessel embodiment of FIG. 3 but could be used in single filter vessels.

When the cartridge filter requires change out, the vessel cover 13 or 45 is removed and any clip(s) temporarily restraining the cartridge(s) within the cartridge insert is released and the cartridge filter is pulled out and replaced. The alignment of the sole cartridge filter within the insert 24 or 41 is not required as it occupies substantially the entire insert.

FIG. 3 shows a multiple bag filter vessel using multiple cartridge filter inserts 41. The inserts 41 are inserted into a cut out flange 46 which can accommodate multiple filter bags each having and forming multiple lips. The cartridge filters 42 can be secured with clips 43 for initial start up. The top 45 of the filter vessel 47 is necessarily displaced so as to allow a head space for fluid that can access the multiple cartridge filters. In all other respects the operation and construction of this multiple vessel embodiment is identical to the single filter vessel unit shown in FIG. 2.

I claim:

1. A liquid filter comprising:
a filter vessel having a removable cover,
a fluid inlet,
an engagement lip for a filter and a fluid outlet,
an open top,
fluid impermeable sidewalls, and
a fluid outlet at a bottom of the insert, into the filter vessel is inserted at least one water impermeable insert having an insert lip engageable in a sealing relationship with the filter vessel engagement lip, a single cartridge filter is inserted within the cartridge filter insert, having a generally solid top surface, a bottom fluid outlet sealingly engageable with the insert outlet and a filter material, wherein the cartridge filter top surface forms a weir and creates an annular opening with the insert, the annular opening having a cross sectional surface which is from 25 to 100% of the cross sectional area of the filter cartridge outlet opening.

2. The liquid filter of claim 1 wherein:
the filter cartridge top surface has a surface area of from 10 to 100 in².

3. The liquid filter of claim 1 wherein:
the filter cartridge top surface has a surface area of from 20 to 50 in².

4. The liquid filter of claim 1 wherein:
the annular opening is from 30 to 70% of the cross sectional area of the cartridge filter outlet.

5. The liquid filter of claim 1 wherein:
the filter vessel has multiple filter inserts which are inserted onto a flange.

6. The liquid filter of claim 1 wherein:
the filter cartridge top surface is 10 to 30 times greater than the area of the annular opening.

7. The liquid filter of claim 1 wherein:
the cartridge filter has a fluid permeable central core,
which extends at one end to the cartridge filter outlet and having a filter media surrounding the core, the cartridge having a top and a bottom formed of a fluid impermeable rigid material.

8. A liquid filter insert and cartridge system comprising a water impermeable insert having a insert lip for insertion onto a filter vessel engagement lip and a single cartridge filter inserted within the cartridge filter insert having a generally solid top surface, a bottom fluid outlet sealingly engageable with the insert outlet and a filter material, wherein the cartridge filter top surface forms a weir for diverting fluid to be filtered toward an annular opening created between the filter cartridge and the insert, the annular opening having a cross sectional area, the filter top surface having a surface area that is 10 to 30 times greater than the annular opening cross sectional area.

9. The liquid filter and cartridge system of claim 8 wherein:
the filter cartridge top surface has a surface area of from 10 to 100 in².

10. The liquid filter and cartridge system of claim 8 wherein:
the filter cartridge top surface has a surface area of from 20 to 50 in².

11. The liquid filter and cartridge system of claim 8 wherein:
the annular opening is from 25 to 100% of the cross sectional area of the cartridge filter outlet.

12. The liquid filter and cartridge system of claim 8 wherein:
the annular opening is from 30 to 70% of the cross sectional area of the cartridge filter outlet.

13. The liquid filter and cartridge system of claim 8 wherein:
the filter cartridge top surface area is 15 to 25 times greater than the area of the annular opening.

14. The liquid filter and cartridge system of claim 8 wherein:
the cartridge filter has a fluid permeable central core,
which extends at one end to the cartridge filter outlet and having a filter media surrounding the core, the cartridge filter having a top and a bottom formed of a fluid impermeable rigid material.
